(19) United States
(12) Patent Application Publication
(10) Pub. No.: US 2004/0225590 A1
(43) Pub. Date: Nov. 11, 2004

(54) Methods and apparatus for automatic bond redemption

(75) Inventors: Michael E. Caporali, Endicott, NY (US); David Hessian, Vestal, NY (US); Christopher T. Johnson, Endicott, NY (US)

Correspondence Address: Randy J. Pritzker, Wolf, Greenfield & Sacks, P.C., 600 Atlantic Avenue, Boston, MA, 02210, US

(73) Assignee: Lockheed Martin Corporation, Bethesda, MD

(21) Appl. No.: 10/431,678

(22) Filed: May 8, 2003

(51) Int. Cl. G06F 17/60

(52) U.S. Cl. 705/36

(57) ABSTRACT

An automatic bond redemption apparatus is provided that facilitates the processing and/or redemption of one or more U.S. Savings Bonds with little or no involvement from employees of a financial institution providing the service. Image data acquired from the savings bond is processed in order to determine bond information related to the nature of the bond, the bond information may be used to index one or more valuation databases in order to determine the value of the savings bond.

### FIELD OF THE INVENTION

This invention relates to the field of banking transactions and, more particularly, to the various tasks of valuation, processing and recordation involved in the redemption of savings bonds.

### BACKGROUND OF THE INVENTION

Financial institutions, such as banks, provide a number of financial services to members and/or customers of the bank. One such service is the redemption of bonds such as any of various investment and/or savings bond. For example, a customer may desire to redeem the value of one or more U.S. Savings Bonds in his or her name. Conventionally, the bond may be brought to an employee of a bank, for example, working as an agent of the United States Treasury Department, who may then enact the redemption of the bond. Bond redemption may involve various tasks including determining the value of one or more bonds, stamping or otherwise marking the bonds, processing the paperwork, recording information related to the transaction, preparing relevant forms and/or documents, etc.

Determining the value of a savings bond may include a bank employee identifying relevant bond information provided on the face of the bond and using this information to index appropriate look-up tables (LUTs) to obtain the value of the bond, for example, the principle value of the bond plus any interest that may have accrued since its date of issue. In particular, a bank employee may be required to ascertain from the bond its series (e.g., EE Bond, Patriot Bond, I Bond, Savings Note, etc.), serial number, the denomination of the bond, and an issue date in order to index one or more databases and/or valuation tables to determine the value of the bond.

The term “database” refers generally to any collection of data or information that may be indexed and may include tables, lists, methods or steps of converting data and/or computing a value, etc. The term “index” refers generally to providing one or more values as an input by which a related value is obtained, determined and/or computed.

Indexing one or more bond valuation databases may include referencing hardcopy volumes of bond value look-up tables. Alternately, bond information may be input by a bank employee info a computer that accesses an electronic database of bond valuation information and/or LUTs. For example, the bank employee may enter bond information into a computer installed with software, for example, a software package known as “BondPro” issued by the United States Treasury Department that, when provided with appropriate bond information, determines the value of the bond. In this way, customers can redeem savings bonds at any of the various financial institutions providing this service.

### SUMMARY OF THE INVENTION

Various underlying concepts of the present invention derive from Applicant's identification and appreciation that many financial institutions as well as the customers they serve may benefit from various methods and apparatus for automated redemption of bonds. By requiring little or no operator involvement, the process of redeeming one or more bonds may be made more time efficient and may preserve the resources of employees of the financial institution to be deployed elsewhere.

One embodiment according to the present invention includes a bond redemption apparatus comprising a scanner adapted to provide image data of at least a portion of a bond, a storage medium encoded with at least one program, and at least one processor coupled to the scanner to receive the image data and capable of accessing the storage medium, wherein the at least one program includes instructions that, when executed by the at least one processor, determine bond information from the image data and index at least one database with the bond information to obtain valuation information related to the bond.

Another embodiment according to the present invention includes a method of valuating a bond, the method comprising acts of receiving as an input a bond, automatically obtaining bond information from the bond and automatically determining valuation information from the bond information.

Another embodiment incorporating various aspects of the present invention includes a bond redemption apparatus comprising at least one input device adapted to acquire image data of a bond, means for automatically determining bond information from the image data and means for determining valuation information from the bond information.

### BRIEF DESCRIPTION OF THE DRAWINGS

FIG. 1 illustrates one embodiment of an automatic bond redemption system according to aspects of the present invention;

FIG. 2 illustrates an embodiment of an automatic bond redemption system implemented as a computer system according to various aspects of the present invention;

FIG. 3 illustrates an embodiment of an automatic bond redemption system according to aspects of the present invention incorporated into a general purpose computing platform; and

FIG. 4 illustrates an embodiment of an automatic bond redemption system according to aspects of the present invention incorporated into an automatic teller machine (ATM).

### DETAILED DESCRIPTION

Conventional bond redemption may require various manual tasks to be performed by a bank employee, agent of a financial institution and/or agent of the United States Treasury Department, including, but not limited to, ascertaining the value of one or more bonds, stamping and/or marking the bonds, preparing forms and/or documents, and recording information associated with the redemption of the bonds. Such a procedure is operator intensive. The term “operator” refers generally to a person, typically a bank employee, involved in carrying out the various tasks necessary to manually valuate a bond. In particular, an operator refers to the individual who manually ascertains bond information (e.g., bond series, serial number, denomination, issue date, etc.,) from the bond and employs that information, ultimately, to determine the value of the bond. In addition, an operator may be responsible for filling out associated paper work, preparing related tax forms, updating account information, etc.

As noted, manual redemption of savings bonds is time consuming, presenting hardships for both the customer and the financial institution. In particular, financial institutions receive relatively small fees for this service in comparison to the value of time lost as a result of employee involvement in the bond redemption process that may otherwise have been deployed in servicing other customers and/or engaging in activities that may provide substantially more income to the financial institution. Furthermore, a customer may be inconvenienced by the need to wait for an available operator before he can redeem his or her bonds and/or by the generally time consuming manual redemption process itself.

Applicant has identified and appreciated that a system for bond redemption requiring little or no operator involvement may provide time and money benefits for institutions providing bond redemption services and increased convenience for the customer. Accordingly, one embodiment according to the present invention includes a system that facilitates automatic redemption of savings bonds.

The term “automatic” refers generally to actions that do not require operator involvement. For example, actions applied by a computer and/or processor are considered to be automatic. In general, rudimentary tasks such as inserting and/or retrieving a bond from a processing apparatus are not considered operator involvement. That is, an automatic system and/or automatic operation may include a person (e.g., the bond holder) to handle these routine and fundamental tasks.

Following below are more detailed descriptions of various concepts related to, and embodiments of, methods and apparatus according to the present invention. It should be appreciated that various aspects of the invention, as discussed above and outlined further below, may be implemented in any of numerous ways, as the invention is not limited to any particular manner of implementation. Examples of specific implementations are provided herein for illustrative purposes only.

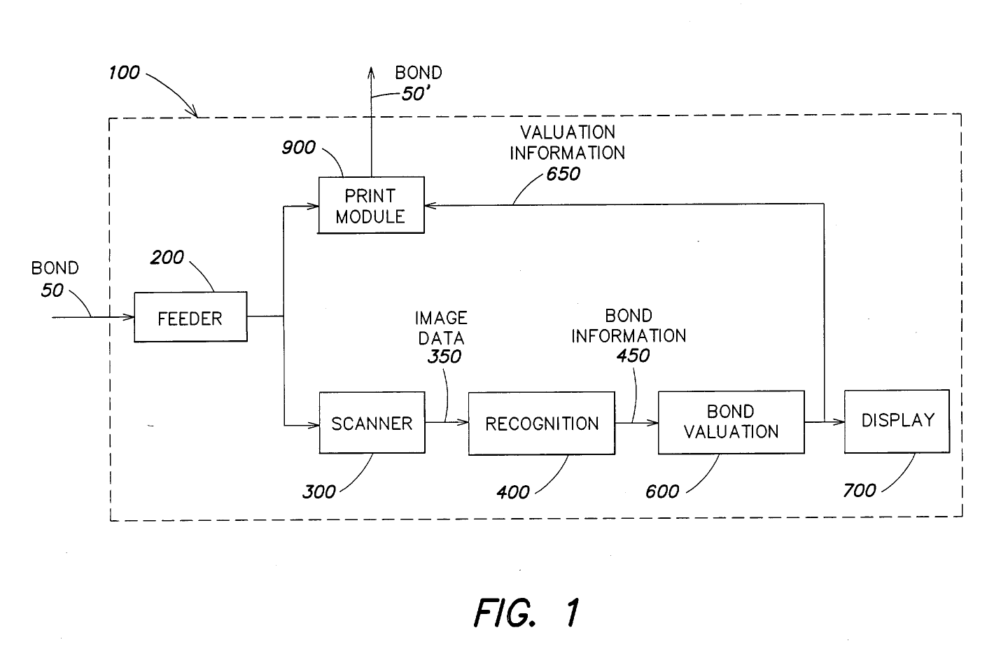

FIG. 1 illustrates one embodiment of an automatic bond redemption system according to the present invention., Automatic bond redemption system 100 includes a feeder 200 coupled to a scanner 300 that provides image data 350 to recognition 400. Recognition 400 provides bond information 450 to bond valuation 600, which in turn generates valuation information 650 based on the received bond information. The valuation information 650 may be provided, for example, to a display 700 and/or print module 900. The operation of the automatic bond redemption system 100 is described in further detail below.

A user and/or bond holder may redeem a bond by, for example, placing a savings bond 50 into feeder 200. Feeder 200 may be any device or combination of devices capable of conveying a savings bond in a desired relationship with, for instance, scanner 300 and/or printer 900. For example, feeder 200 may be any of various electromechanical feeders similar to those found in various vending machines, electronic kiosks, automatic teller machines (ATMs), etc., suitable for transporting a bond in a generally known orientation with scanner 300. Feeder 200 may also include various sensing components adapted to detect when a bond has been introduced to the feeder.

Scanner 300 may be any device or combination of devices capable of capturing image data. For example, any of various scanners that emit radiation and measure the interaction of the radiation with a surface, for example, by detecting back-scattered radiation may be employed to capture and provide image data 350. For example, a scanner may provide a representation of the detected radiation such as intensity (e.g., the magnitude of the reflected radiation) as a function of space, for instance, as pixels in an image.

A variety of optical and lasers scanners are available today and may be integrated into automatic redemption system 100 as either part of the feeder or separate from the feeder. For example, a charge couple device (CCD) array may be integrated into the feeder such that the feeder conveys the bond in a proximate relationship to the CCD array whereby an image of at least a portion of the savings bond may be obtained. Image data 350 generated by scanner 300 and related to subject matter appearing on bond 50 may then be provided to recognition 400 for further processing.

Recognition 400 may be any of various image processing methods adapted for or contributing to recognizing patterns in the image data and providing the image data in, for example, character form according to ASCII, UNICODE or any other machine understandable character standard and/or format. For example, recognition 400 may be configured to recognize patterns in the image data as belonging to alpha-numeric and/or other generally human readable symbols such as letters, words, numbers etc., and to provide a value, attribute and/or label to the pattern that indicates the recognized symbol. This process is referred to generally as optical character recognition (OCR). In addition, recognition 400 may be configured to recognize any of various other patterns and encodings, for example, barcode representations, generally computer readable symbols and encodings, or any other encodings designed to convey information about the bond.

Recognition 400 may include any of various filtering and/or preprocessing methods, segmentation procedures and/or recognition algorithms such as neural networks, template matching, mathematical morphology, fuzzy logic methods, etc., that facilitate recognizing patterns in the image data provided by the scanner. Any of numerous recognition schemes may be employed provided they are capable of extracting bond information from an image of the subject matter appearing on at least a portion of a savings bond.

The term “bond information” refers generally to any information available and/or appearing on the bond and, more particularly, to information provided on the bond that may facilitate determining the nature, identity and/or value of the bond or that may aid in actions related to redeeming the bond. Exemplary bond information may include one of more of bond series, serial number, denomination, issue date, bond holder identification, etc., but is not so limited. For example, bond information may include any information that an operator would conventionally ascertain from the bond during a manual redemption.

Recognition 400 may also include various methods that, based on the content of image data 350, determine whether or not a savings bond 50 has been inserted correctly into the feeder 200. For example, image data 350 may include a digital image of at least a portion of the savings bond 50 inserted into feeder 200. Recognition 400 may include methods to analyze particular regions of the image where target information is known a priori to exist when a bond is inserted correctly, for example, a bond serial number or other landmark printed or otherwise appearing on the face of the bond. If recognition 400 does not detect the target information, the feeder may be signaled to reverse its feed and return the bond to the user. If the target information is detected, recognition 400 may proceed to extract the desired bond information from image data 350.

In one embodiment, recognition 400 analyzes an image of the savings bond at regions corresponding to portions on the actual bond where information relevant to determining the value of the bond may be printed. For example, recognition 400 may recognize the bond series, serial number, denomination, and/or issue date of the savings bond and provide this information to bond valuation 600 as bond information 450. Bond information 450 may then be used to determine the current value of the savings bond.

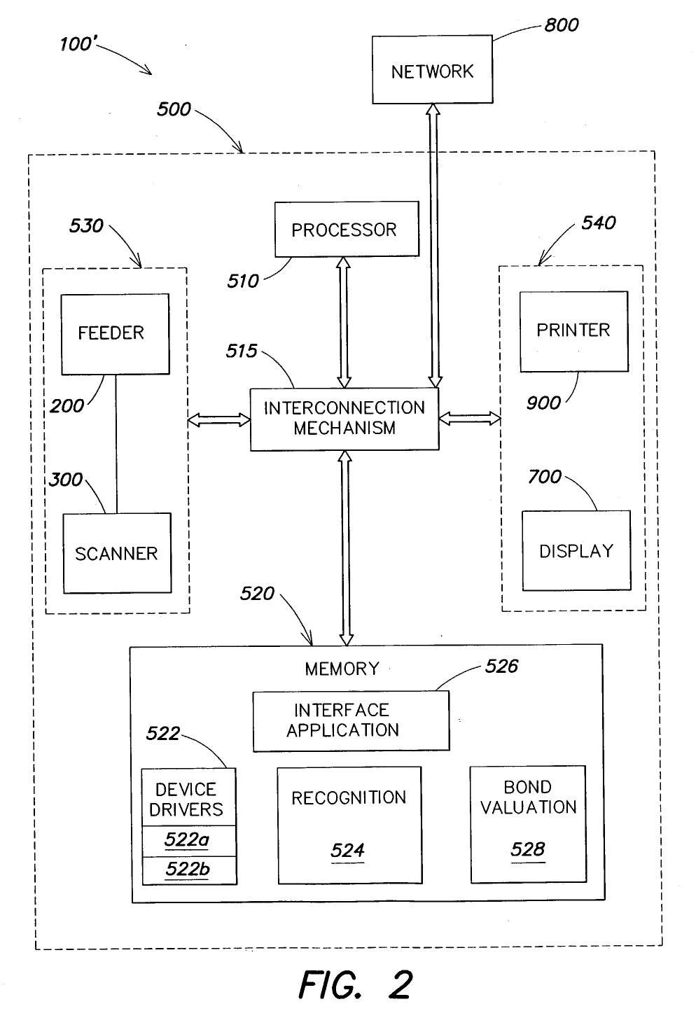

Bond valuation 600 may be any suitable mechanism for calculating the value of the savings bond when provided with appropriate bond information 450. For example, bond valuation 600 may include the software program “BondPro” issued by the United States Treasury Department to calculate any interest that may have accrued on the bond and thus, ultimately, the current value of the bond. However, bond valuation may include any methods or programs configured to determine the value of a bond from bond information, for example, by accessing one or more databases available over a network or by utilizing any of various software programs developed for such a purpose. In addition, bond valuation software may include various other programs, components, modules or interfaces necessary to interact with a valuation software component (e.g., BondPro) or other bond valuation databases and/or LUTs as described in further detail in connection with FIG. 2.

Bond valuation 600 may receive bond information 450 extracted from the scanned image of the savings bond and use the bond information to index a bond valuation database. Bond valuation provides valuation information 650 resulting from indexing or querying a bond database or otherwise determining the value of the bond. The term “valuation information” refers generally to any information related to or indicating a value of a bond. Valuation information may also include bond information in addition to an indication of the value of the bond. Valuation information 650 may then be displayed to the user, printed on the bond, sent electronically over a network, etc.

For example, bond information may be transmitted to display 700 for viewing by a user. A user may examine the valuation information and determine if he or she would like to redeem the bond, verify information about the bond, cancel the transaction, etc. If the bond holder indicates that he or she would like to redeem the value of the bond, the relevant valuation information may be sent to print module 900 to be printed on the bond, printed on various other printable media, or electronically transmitted to a remote location such that the valuation information is available to complete the redemption of the bond. In this manner, a user may process and/or redeem one or more savings bond with little or no operator assistance or resources. In addition, a user may redeem bonds at his or her leisure without having to wait for the availability of an operator, such as a bank employee and/or agent of the United States Treasury Department.

After valuation information has been printed, for example, on the bond, on a receipt or other printable media, a user may take the processed bond 50′ and/or any printed material to, for instance, a teller window in order to redeem its value. In addition, valuation information may be transmitted over a network (not shown) to, for example, a computer system of a financial institution as described in more detail in connection with FIG. 2. The valuation information may also be used to automatically generate tax preparation forms, for instance, 1099 forms that may need to be filed for tax purposes as a result of redeeming a bond, may update account information and/or records, generate documentation related to the transaction, etc.

Some embodiments of automatic redemption system 100 may not include a feeder. A user may directly interact with the scanner itself by, for example, placing a savings bond directly on a scanning device or manipulating any of various hand held scanners to obtain image data of the savings bond. However, a feeder may require less user ‘know-how’ and may reduce the chance of user error, for example, introducing the bond to the scanner upside down or at an incorrect orientation. Furthermore, other elements may be optional, for example, the display 700, print module 900, etc.

FIG. 2 illustrates one embodiment of a computer system implementing various aspects of the present invention. Automatic redemption system 100′ includes computer system 500 having a processor 510 connected to one or more memory devices including memory 520. Memory 520 may be any of various computer-readable media, for example, a non-volatile recording medium, an integrated circuit memory element, volatile memory, or a combination thereof and may be implemented in numerous ways, such as, but not limited to, RAM, SRAM, DRAM, ROM, PROM, EPROM, EEPROM, CD, DVD, optical disks, floppy disks, magnetic tape, and the like.

Memory 520 may be encoded with instructions, for example, as part of one or more programs that, as a result of being executed by processor 510, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBAL, etc., or any of a variety of combinations thereof. For example, memory 520 may include one or more programs or software components including device drivers 522, recognition component 524, interface application 526, and bond valuation component 528 as described in further detail below.

The various components of computer system 500 may be coupled together by an interconnection mechanism 515, which may include one or more busses (e.g., between components that are integrated within a same machine) and/or a network (e.g., between components that reside on separate discrete machines) using electrical or optical conductors, cables, wireless communications, etc. The interconnection mechanism 515 enables communications (e.g., data, instructions, control) to be exchanged between system components of computer system 500.

Computer system 500 may include one or more input devices 530, for example, scanner 300 adapted to provide image data to interconnection 515 and thus to the various components of computer system 500 and feeder 200 capable of conveying a savings bond in a proximate relationship with scanner 300. Computer system 500 may also include one or more other input devices (not shown) such as a keyboard, mouse, touch screen, etc. Computer system 500 may additionally include one more output devices 540, for example, display 700 and print module 900.

In FIG. 2, various aspects of the present invention are implemented as software components encoded in memory 520 and capable of being executed by processor 510. An interface application 526 may be configured to communicate with the various software components resident in memory 520 (e.g., device drivers 522, recognition component 524, bond valuation component 528, etc.).

Device drivers 522, for example, may include one or more low level software drivers configured to communicate with the various hardware components comprising computer system 500 (e.g., scanner 300, feeder 200, printer 900, display 700, etc.). Device drivers 522 may include a software driver configured to communicate with scanner 300 according to any of various connection and/or data transmission protocols.

For example, device driver 522a may communicate with scanner 300 according to various parallel communications standards such as Enhanced Capability Port (ECP) or serial communications standards such as Universal Serial Bus (USB), small computer system interface (SCSI) or a proprietary and/or customized protocol developed to communicate with scanner 300. Device driver 522a may be adapted to obtain image data that may be transmitted to interface application 526 to be, for example, assembled into a digital image of the savings bond or in some other desired format that facilitates recognizing and extracting bond information from the image of the savings bond.

In addition, one or more of device drivers 522 may be configured to communicate with feeder 200. For example, a device driver 522b may communicate with the electro-mechanical hardware to instruct a conveyance mechanism of the feeder to begin motion, the speed at which to operate, which direction to move, when to stop, etc. Accordingly, the hardware components of computer system 500 may be controlled by software components installed in memory 520.

Recognition software 524 may be configured to recognize patterns in the image data resulting from the subject matter printed on the bond. For example, recognition component 524 may group pixels together as belonging to a particular structure and may identify the nature of the particular structure, for example, as an alpha-numeric character and/or a series of alpha-numeric characters representing bond information 450. Recognition component 524 may also be configured to recognize other patterns such as specific regions of the bond, any of various landmarks, or any other structure in the image that facilitates the detection and identification of relevant bond information in the image. For example, recognition component 524 may include instructions configured to interpret an image of a barcode representation in order to extract bond information from the encoding.

In some embodiments, recognition 524 may analyze an image to detect the presence or absence of particular target subject matter at a particular location known a priori to appear on a bond placed correctly in the feeder. Upon detecting the absence of the target subject matter, recognition 524 may indicate the absence to the interface application 526 which may instruct feeder 200 to reverse its feed, via device driver 522b, such that the bond may be returned to the user. Upon detecting the presence of the target subject matter, recognition 524 may proceed to recognize and extract bond information from the image data related to subject matter appearing on the savings bond.

Interface application 526 may receive bond information from the recognition component 524 and arrange it in a format understandable to bond valuation component 528, for example, in the form of a database query. Bond valuation component 528 may be any program or combination of programs capable of determining the value of a bond from the appropriate bond information. For example, bond valuation component 528 may use the issue date, denomination and type of bond extracted as bond information from the image of the saving bond to index a database and/or look-up table of bond valuation information to determine, for example, the principal on the bond, any interest that may have accrued since the issue date, etc., such that the current value of the bond may be ascertained. Bond valuation software component 528 may include, for instance, the BondPro software package distributed by the United States Treasury Department. The obtained valuation information may then be provided to interface software 526 for display, manipulation and/or transmission, etc.

Interface application 526 may be any program or combination of programs that by facilitating transfer and manipulation of data between one or more other programs, coordination of data flow, and/or provision of a user interface etc., controls an automatic redemption of one or more savings bond. For example, interface application 526 may be configured to establish connection with interfaces exposed by other software components by, for instance, static or dynamic linking, employing component object model (COM) interfaces, discharging scripts, or any of other various software engineering techniques available for communication between software components.

Interface application 526 may also include a user interface transmitted to display 700 to guide a user through the automatic redemption process, instruct the user of errors, for example, when a user inserts a bond into the feeder incorrectly, display the results of the bond valuation, etc. In some embodiments, display 700 may be a touch sensitive device operating as both an input and an output device.

In addition, interface application 526 may be programmed to automatically generate any of various recordkeeping, bookkeeping or administrative information related to the redemption of the bond. For example, interface application 526 may generate tax preparation information needed to submit an appropriate 1099 tax form. In addition, interface application 526 may communicate with a network 800 connecting the automatic redemption system to, for example, various other computers of the financial institution, one or more electronic accounts or databases, the Internet, etc.

As used herein, a “network” or a “communications network” is a group of two or more devices interconnected by one or more segments of transmission media on which communications may be exchanged between the devices. Each segment may be any of a plurality of types of transmission media, including one or more electrical or optical wires or cables made of metal and/or optical fiber, air (e.g., using wireless transmission over carrier waves) or any combination of these transmission media.

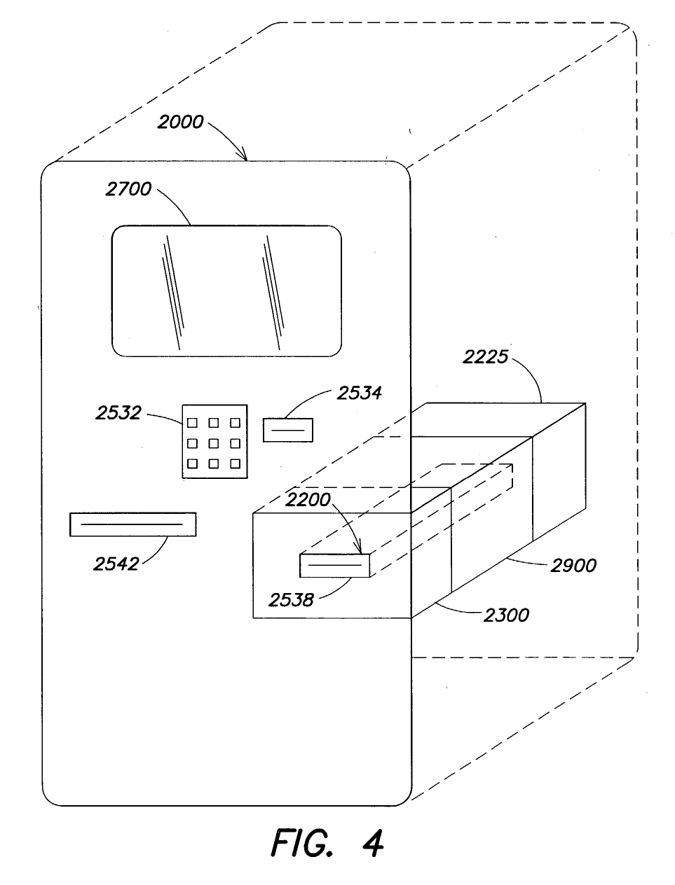

For example, computer system 500 may be connected to a network 800 such as a bank local area network (LAN), a wide area network (WAN) and/or the internet. Interface application 526 may include one or more network programs configured to communicate according to any of various network protocols such as TCP/IP, FTP, etc. to exchange data with the network and/or other devices connected to the network. For example, interface application 526 may transmit data related to the redemption of the bond (e.g., valuation information) to one or more accounts the user may have established with the financial institution or accessible by the financial institution over the network 800. In this manner, the value of the bond may be automatically credited to the user's account as described in further detail in connection with FIG. 4.

In an alternative embodiment, one or more of the portions of computer system 500 may be distributed across one or more computer systems (not shown) coupled to network 800. For example, various aspects of the invention may be performed on a client-server system that includes components distributed among one or more server systems that perform various functions according to various embodiments of the invention. For example, bond valuation component 528 may reside on one or more devices or computer systems connected to network 800. Interface application 526 may then transmit bond information over the network in order to obtain valuation information from bond valuation software residing on the network. Similarly, recognition 524 or any of the various other software components need not reside locally but may be distributed over a network.

It should be appreciated that the software components encoded in memory 520 or distributed over a network need not be logically organized as illustrated in FIG. 2, but may interact in any of the various ways that will occur to those skilled in the art. For example, the various software modules may be stand-alone applications executed by, for example, a script. Alternatively, the individual modules may be implemented as COM objects, OLE objects or the like. Any of various software architectures, structures and engineering techniques that will readily occur to those skilled in the art suitable for capturing image data and extracting bond information from the image data to facilitate the determination of the value of a bond is considered to be within the scope of the invention.

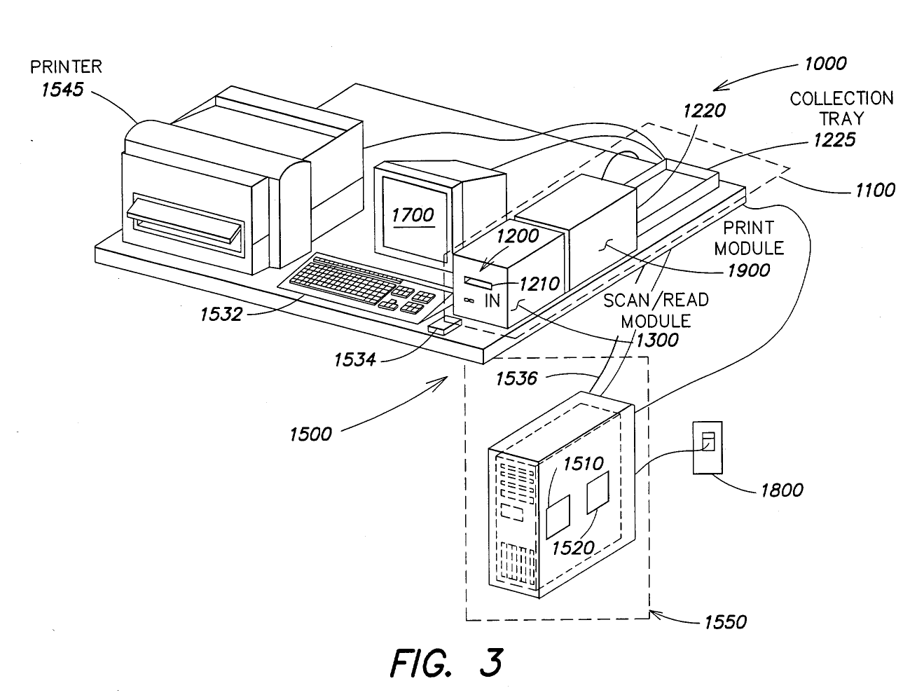

FIG. 3 illustrates an embodiment of an automatic redemption system 1000 according to the present invention implemented in connection with any of numerous types and varieties of personal computers (PCs) and peripherals that may be commercially available. For example, automatic redemption system 1000 may comprise a generally available computer system 1500 having a computer 1550 and any of various standard peripheral devices such as keyboard 1532, mouse 1534, monitor 1700 and printer 1545.

As is often standard in general consumer PCs, computer 1550 may include a processor 1510, for example, a commercially available processor such as the well-known Pentium class processor available from the Intel Corporation and one or more memories 1520 accessible by the processor, for example, a high capacity hard drive, a processor-dedicated fast cache, etc. Computer 1550 may include any of various ports offered for general purpose PCs such as one or more parallel ports, serial ports, USB ports, network ports, etc. It should be appreciated that any of the general purpose computing systems available, such as those likely to be in place at any financial institution, are suitable platforms to implement various aspects of the present invention.

Automatic redemption system 1000 also includes automatic redemption device 1100. Automatic redemption device 1100 may be attached to computer 1550 in the same manner as other peripherals, for example, by connecting the device to a USB port of computer 1550 via cable 1536. Automatic redemption system 1000 may include a scan module 1300 and a print module 1900. An automatic feeder 1200 may be arranged to convey a savings bond from an input slot 1210 to an output slot 1220 to deposit it, for example, in a collection tray 1225.

In addition, computer 1550 may have one or more software programs installed on internal memory devices 1520 that, when executed by processor 1510, perform various aspects of the invention such as those described in connection with FIG. 2. In particular, the one or more memory devices 1520 may include one or more device drivers to communicate with the hardware components of automatic redemption device 1100, for example, feeder 1200, scan module 1300 and print module 1900. In addition, the one or more memory devices 1520 may include a program configured to obtain bond information from image data provided by scan module 1300. Memory devices 1520 may further include a program configured to obtain valuation information based on the generated bond information.

According to one aspect of the present invention, the one or more software programs includes a user interface, for example, as part of an interface program. For example, the user interface may include a default message displayed on monitor 1700 instructing a user to insert a bond into slot 1210 to begin the redemption process. The user interface may then instruct the user and guide him or her through the automatic redemption process.

Feeder 1200 may include electromechanical components that sense when a bond has been inserted into the slot and may be adapted to grip the bond and pull it into device 1100. The feeder 1200 may send a signal over cable 1536 to alert the interface program that a savings bond has been inserted into device 1100. The feeder may then guide the bond proximate to a scanning device in scan module 1300, for instance, an array of CCD elements, or a laser source, adapted to capture an image of portions of the savings bond. The image information obtained by the scan module may then be transferred to computer system 1550 over cable 1536, for example, under the control of a device driver installed on the one or more memories of computer 1550.

The image data acquired by scan module 1300 may be provided as input to one or more OCR software components installed on computer 1550 such that bond information can be recognized and extracted from the image of the savings bond. The bond information may then be input into bond valuation software installed on the computer system 1550 or located on a device connected to network 1800 in order to determine the value of the savings bond. The resulting valuation information may be transferred to monitor 1700 such that the bond holder may view the current value of his or her bond.

The user interface program may provide the bond holder with the option of either redeeming the bond or canceling the redemption. Upon choosing to redeem the bond, valuation information may be printed on the bond by print module 1900 and the bond may be deposited in collection tray 1225. In addition, the interface software may automatically generate or, via a prompt, provide the user an option of selecting the generation of tax preparation forms, receipt information, or other documentation related to the redemption of the savings bond. This information may be printed on printer 1545 and/or transmitted to other devices and/or computers connected to network 1800, for example, to update the bond holders account information, electronic profiles, etc. In addition, validation information may be printed and submitted to a bank teller in order that the bond holder receive cash in return for the savings bond.

In this manner, a bond holder can determine the value of one or more savings bond unaided by a bank employee or other authorized operator. In addition, a bond holder may be able to redeem the value of one or more bonds simply by submitting the processed bond and any other printed subject matter as described above at a teller window of the financial institution. It should be appreciated that the time consuming elements of the procedure of redeeming savings bonds have been automated, thus freeing bank employees to engage in other activities that may be more profitable to the bank. In addition, a bond holder may operate more or less independently, allowing the holder to determine and/or redeem the value of his savings bond efficiently and with substantially the same effort as depositing a check or conducting various other standard bank transactions.

Applicant has identified and appreciated that further benefit to both the financial institution and the bond holder may be achieved by facilitating the redemption of one or more savings bond without any operator assistance or involvement at the time the bond holder processes the bond. According to one embodiment of the present invention, bond redemption may be completed from an automatic teller machine (ATM) and/or customized electronic kiosk without involving either an operator or a teller at the time of the redemption.

The ATM paradigm is a well established and familiar mode of handling many routine financial transactions such as obtaining cash from a debit account, depositing cash and/or checks into a savings, checking and/or debit account, transferring funds between accounts, etc. The general user is comfortable conducting financial transactions in this manner and interfacing with an ATM machine has become well understood by the average customer. Various aspects of the present invention may be incorporated into the ATM model such that a bond holder may determine and/or redeem the value of his bond at an ATM location or at a customized kiosk implementing the ATM model.

FIG. 4 illustrates one embodiment of an automatic redemption system according to the present invention incorporated into an ATM. ATM 2000 may include standard features such as a display 2700, keypad 2532 an insert 2534 for an ATM or debit card, and a dispenser 2542 for cash, stamps, etc. ATM 2000 may also include an insert 2538 for a savings bond. For example, insert 2538 may be a modified insert of existing inserts and/or feeders used in conventional ATMs adapted to obtain envelopes containing cash and/or check deposits from an ATM user.

Insert 2538 may be adapted such that US Savings Bonds can be inserted or deposited into the ATM machine. Insert 2538 may be coupled to scan module 2300, for example, a feed mechanism schematically illustrated as feeder 2200 of insert 2538 may convey inserted bonds to scan module 2300 such that an image of the savings bond may be acquired. The feed mechanism 2200 may be further coupled to print module 2900 adapted to print subject matter on the bond and/or print various other information, for example, a receipt that may be returned to the user via dispenser 2542 or otherwise.

ATM 2000 may also include one or more processors (not shown) coupled to various memory devices (not shown), for example, any of standard computing platforms and configurations typically located in conventional ATMs to conduct the various financial transactions and services offered by ATMs. For example, ATM 2000 may include a processor coupled to a memory encoded with one or programs configured to extract bond information from image data of a savings bond and index one or more databases with the bond information to obtain valuation information of the bond as described in the foregoing.

Accordingly, a bond holder may use ATM 2000 to redeem the value of one or more savings bonds. For example, a bond holder may begin the redemption process by inserting, for example, a debit card associated with one or more electronic accounts such as a savings account, checking account, etc., into the ATM. The bond holder may be asked to enter a personal identification number (PIN) associated with the one or more electronic accounts and/or card as may typically be done in conventional ATM transactions such as a money withdrawal.

A user interface of the ATM may include a bond redemption option that may be selected by the bond holder to begin the bond redemption process. The user interface may then guide the bond holder through the process of redeeming the bond, for example, by prompting the bond holder to insert the bond into insert 2538, prompting the user to select an associated account with which to deposit the proceeds of the bond, a cash back option, etc. Once the bond has been inserted, the automatic redemption portion of ATM 2000 may automatically carry out the various functions that may be required to redeem the bond as described in the foregoing.

Furthermore, once valuation information has been obtained from bond information extracted from an image of at least a portion of the savings bond, the valuation information may be displayed to the user along with a prompt asking the bond holder whether he or she would like to proceed with redeeming the bond. If the bond holder selects that he does not want to redeem the bond, ATM 2000 may return the bond to the bond holder via insert 2538. If the bond holder selects that he or she does want to redeem the value of the bond, ATM may stamp, mark, or otherwise print relevant subject matter on the bond related to the redemption and convey the bond to a secure location within the ATM, for example, secure bin 2225. The selected account may then be updated according to the value of the bond.

The user interface may query the bond holder whether he or she desires to process any more bonds. When all transactions are complete, the ATM may print the results of the transaction on a receipt and dispense the receipt to the user. It should be appreciated, that actual funds related to redemption of one or more bonds may not be immediately credited to an account. For example, a handler and/or bank employee may need to verify that the deposited bond belongs to a person as represented during the ATM transaction and that the bank account is associated with correct and/or authorized persons. Such verification procedures may be similar to those conducted for ATM check deposits into money accounts. However, this verification procedure may be entirely transparent to the user and may be conducted after the bond holder has interacted with the ATM in order to process the bond. Once the transaction has been verified, the value of the bond may be fully credited to the account.

Automatic bond redemption apparatus such as the various embodiments described in the foregoing may precipitate a transition from printing generally human readable characters (e.g., alpha-numeric characters forming words and/or numbers) to generally machine readable characters such as a barcode in order to further facilitate the automatic bond redemption process. For example, bond series, serial number, denomination, issue date, etc., may be encoded on the bond in the form of a barcode or other format generally designed to be interpreted by a computer.

As such, in one embodiment of the present invention, recognition software includes instructions configured to interpret image data including a barcode representation as bond information. In addition, a scanner providing image data related to a bond may be any of various barcode readers that are generally available, for example, mounted barcode readers similar to those installed in many super markets and/or hand held devices such as light pens, wands, or laser guns often used at retail locations. It should be appreciated that the scanner need not be specifically a bar code reader but may be any scanning device configured to acquire image data of an encoding designed generally to be interpreted by a computer. Accordingly, various embodiments of the present invention may be adapted and/or extended to include automatic redemption of saving bonds having bond information encoded to facilitate machine understanding and interpretation.

Having described several embodiments of the invention in detail, various modifications and improvements will readily occur to those skilled in the art. Such modifications and improvements are intended to be within the scope of the invention. While some examples presented herein involve specific combinations of functions or structural elements, it should be understood that those functions and elements may be combined in other ways according to the present invention to accomplish the same or different objectives. In particular, acts, elements and features discussed in connection with one embodiment are not intended to be excluded from a similar role in other embodiments. Accordingly, the foregoing description is by way of example only, and is not intended as limiting. The invention is limited only as defined by the following claims and the equivalents thereto.

What is claimed is:

1. A bond redemption apparatus comprising:
a scanner adapted to provide image data of at least a portion of a bond;
a storage medium encoded with at least one program; and
at least one processor coupled to the scanner to receive the image data and capable of accessing the storage medium,
wherein the at least one program includes instructions that, when executed by the at least one processor, determine bond information from the image data and index at least one database with at least some of the bond information to obtain valuation information related to the bond.

2. The apparatus of claim 1, further comprising an input portion adapted to receive the bond.

3. The apparatus of claim 2, further comprising a transport mechanism adapted to move the bond from the input portion proximate the scanner.

4. The apparatus of claim 3, wherein the transport mechanism includes an automatic feeder.

5. The apparatus of claim 3, further comprising a display adapted to display at least the valuation information.

6. The apparatus of claim 1, wherein the storage medium includes at least one memory.

7. The apparatus of claim 1, wherein the at least one program includes instructions that perform optical character recognition to determine at least one of bond series, bond serial number, bond denomination, and bond issue date from the image data.

8. The apparatus of claim 7, wherein the scanner includes an optical scanner.

9. The apparatus of claim 1, wherein the at least one program includes instructions that perform recognition of a machine understandable encoding to determine at least one of bond series, bond serial number, bond denomination, and bond issue date from the image data.

10. The apparatus of claim 9, wherein the at least one program includes instructions that perform recognition on an image of a barcode acquired from the scanner.

11. The apparatus of claim 10, wherein the scanner includes a laser scanner.

12. The apparatus of claim 5, wherein the scanner, the storage medium, the at least one processor, the transport mechanism and the display are housed in an automatic teller machine having access to at least one electronic account.

13. The apparatus of claim 12, wherein the at least one program includes instructions configured to update the at least one electronic account based on the valuation information.

14. The apparatus of claim 1, in combination with at least one network.

15. A method of valuating a bond, the method comprising acts of:
receiving as an input a bond;
automatically obtaining bond information from the bond; and
automatically determining valuation information from the bond information.

16. The method of claim 15, wherein the act of automatically obtaining bond information from the bond includes an act of scanning the bond to provide image data of the bond.

17. The method of claim 16, wherein the act of automatically obtaining bond information from the bond includes an act of determining the bond information from the image data.

18. The method of claim 17, wherein the act of automatically obtaining bond information from the bond includes an act of performing optical character recognition on the image data to obtain at least one of bond series, bond serial number, bond denomination, and bond issue date from the image data.

19. The method of claim 17, wherein the act of automatically obtaining bond information from the bond includes an act of recognizing at least one encoding essentially configured to be interpreted by a computer from the image data to obtain at least one of bond series, bond serial number, bond denomination, and bond issue date from the image data.

20. The method of claim 19, wherein the at least one encoding essentially configured to be interpreted by a computer includes at least one barcode.

21. The method of claim 17, wherein the act of automatically determining valuation information includes an act of indexing at least one database with the bond information to obtain the valuation information.

22. The method of claim 15, further comprising an act of automatically generating at least one document based on the valuation information.

23. The method of claim 15, further comprising an act of accessing at least one electronic account for update based on the valuation information.

24. The method of claim 23, further comprising an act of updating at least one electronic account based on the valuation information.

25. A bond redemption apparatus including:
at least one input device adapted to acquire image data of a bond;
means for automatically determining bond information from the image data; and
means for determining valuation information from the bond information.

26. The bond redemption apparatus of claim 25, wherein the at least one input device includes at least one scanner.

27. The bond redemption apparatus of claim 25, wherein the at least one input device includes an automatic feeder.

28. The automatic redemption apparatus of claim 25, wherein the means for automatically determining bond information from the image data include at least one recognition program.

29. The automatic redemption apparatus of claim 25, wherein the means for determining valuation information include at least one valuation database.

30. The automatic redemption apparatus of claim 25, wherein the means for automatically determining bond information and the means for determining valuation information include at least one computer readable medium encoded with at least one program having instructions configured to recognize the bond information from the image data and index at least one valuation database with the bond information to obtain the valuation information.
